(19) United States
(12) Patent Application Publication
(10) Pub. No.: US 2006/0242572 A1
(43) Pub. Date: Oct. 26, 2006

(54) Viewer for protected content as a programming platform component

(75) Inventors: Heather L. Grantham, Redmond, WA (US); Jerry J. Dunietz, Seattle, WA (US); Marcio De Mello, Bellevue, WA (US); Anthony L. Willie, Woodinville, WA (US); Young Gah Kim, Bothell, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/111,734

(22) Filed: Apr. 22, 2005

(51) Int. Cl. G06F 17/00

(52) U.S. Cl. 715/526

(57) ABSTRACT

A system and method are provided for implementing a content viewer for fixed-format documents. An existing document may be “published” to create a fixed-format document using the user interface of the exiting document's native application. The content viewer is integrated into an application program interface, reducing the burden of software maintenance and enhancing security features. The content viewer invokes a web browser, which provides a host environment for the viewer to display the published document.

### CROSS-REFERENCE TO RELATED APPLICATIONS

None.

### STATEMENT REGARDING FEDERALLY SPONSORED RESEARCH OR DEVELOPMENT

None.

### TECHNICAL FIELD

Embodiments of the present invention relate to a system and method for implementing a viewer for protected content and in particular to a system and method for integrating the viewer with other software applications.

### BACKGROUND OF THE INVENTION

Authors of documents and other users often wish to transmit documents in a fixed file format, such as a PDF file. Transmitting a document in a fixed file format ensures that the document remains intact and is not edited or otherwise altered.

When a fixed-file document is received, a software application known as a viewer is used to view the document. Viewers for fixed-file documents, such as Acrobat for PDF, have previously been implemented as independent applications. These applications are invoked, for example, when an operating system recognizes a well-known component in the files name, usually an extension, such as “.pdf.”

When a viewer is implemented as stand-alone application, users of the viewer are responsible for ensuring the viewer is functioning. Typically, a user is required to download, install, and maintain the software. The user may also be responsible for ensuring that the correct viewer is invoked for a particular version of content, and that that software will run on the installed operating system platform

In addition, viewers implemented as external applications and invoked by file extension can be easily replaced or substituted. This introduces the risk of a malicious replacement of the viewer and reduces user confidence in the viewer.

Furthermore, because the viewer is a stand-alone application, customizations made in the operating system are not typically reflected when viewing fixed-format documents. For example, a visual theme selected in the operating system may not be reflected when viewing documents. This may disrupt the overall experience when switching between different content types.

Accordingly, a solution is needed for providing a viewer that does not require a user to download, install, and maintain the software. In addition, there is a need for a viewer with enhanced security protection that increases user confidence. Furthermore, there is a need for a viewer in which customizations made in the operating system are reflected when viewing documents.

### BRIEF SUMMARY OF THE INVENTION

Embodiments of the present invention include a method for viewing a fixed-format document. The method may include receiving a document into a viewer integrated with an application program interface and determining whether the document is of a predetermined fixed-format content type. The method may also include presenting the document to a user via a web browser if the document is of the predetermined fixed-format content type.

In additional aspects, a system for viewing a fixed-format document is provided. The system may include an application program interface and a viewer. The viewer may be integrated with the application program interface, and the application program interface and the viewer may be installed in a single installation.

In still further aspects of the invention, a user interface system for generating a fixed-format document is provided. The user interface system may include a user-selectable print-to-fixed-format option, presented to a user in a document's native environment, that generates a fixed-format document in accordance with an application program interface. The fixed-format document may be viewable via a viewer, the viewer being integrated with the application program interface.

### BRIEF DESCRIPTION OF THE DRAWINGS

The present invention is described in detail below with reference to the attached drawings figures, wherein:

FIG. 1 is a block diagram illustrating an overview of a system in accordance with an embodiment of the invention;

FIG. 2 is block diagram illustrating a computerized environment in which embodiments of the invention may be implemented;

FIG. 3 is a flow chart illustrating a method for publishing a fixed-format document in accordance with an embodiment of the invention;

FIG. 4 is a flow chart illustrating a method for viewing a fixed-format document in accordance with an embodiment of the invention; and

FIG. 5 is an exemplary user interface in accordance with an embodiment of the invention.

### DETAILED DESCRIPTION OF THE INVENTION

I. System Overview

A system and method are provided for implementing a fixed-format viewer. The viewer may be used to view documents of a predetermined file format.

The system may include a terminal 200, which may be configured to receive input 202 from a network, a disk drive, a CD ROM, or the like. The terminal 200 may further include storage 203. The terminal 200 may further include an Application Program Interface (API) 204 and a viewer 206. The viewer 206 is implemented, for example, as an integrated part of the API 204, and is installed concurrently with the API 204.

The terminal 200 may further include an operating system 207 and a web browser 208, which retrieves and displays web pages. The terminal 200 may also include or communicate with a display 210, which displays information to a user.

Fixed-format files may be received, for example, from the input 202, or may be retrieved from storage 203. When a user wishes to open a fixed-format file, the user so indicates, for example, by double-clicking on an icon representing the file. The operating system 207 may then invoke the viewer 206. Furthermore, the web browser 208 may be invoked, for example, either by the operating system 207 or by the viewer 206. The web browser 208 opens a window used to display the fixed-format document, or otherwise provides a host environment for the fixed-format document. The fixed-format document is presented to the user via the display 210, in the host environment provided by the web browser.

In one implementation, the API 204 determines the format of a fixed-file document, for example, by identifying a file extension or other relevant information. When it is determined that the fixed-file document is of an appropriate format, the API 204 invokes the viewer. The API 204 further includes methods used to host applications in the browser 208. These methods are used to view fixed-file documents in the browser 208.

Because the viewer 206 is incorporated into the API 204 or is installed concurrently with the API 204, the viewer 206 can be included as a trusted component of the API 204. Thus, applications using the API 204 can guarantee that the viewer 206 will not make untrustworthy requests of the web browser 208, the operating system 207, or any other related application.

Furthermore, the viewer 206 is implemented as a sealed application class within the API 204. Because the viewer is a sealed application class, input or inheritance are disallowed, both from other internal applications (other applications incorporated into the API 204) and from external applications that use the API 204. This implementation ensures that malicious users cannot derive or extend the application, so that content originating from the viewer may be trusted.

Because both content and requests originating from the viewer are trusted, it is unnecessary to present the user with information regarding potential hazards. Thus, dialog boxes warning of potential hazards may be eliminated, resulting in increased consumer confidence in the viewer.

Because the viewer 206 displays documents hosted in the web browser 208, the user is presented with a fixed-format document that has the appearance of a web page. This allows the user to utilize features of the web browser 208, such as navigating through the document using the web browser's 208 “forward” and “back” buttons.

Furthermore, because the viewer 206 is included in the API 204, the viewer 206 can utilize the visual theming set for internal applications. Thus, continuity of user experience may be preserved, even when switching between content types.

In addition, the viewer 206 may interface with a graphics and presentation engine, such as the Microsoft Avalon graphics engine. This allows the viewer 206 to inherit benefits of the graphics and presentation engine, allowing for enhanced presentation of gradients, 3-dimensional images, graphics, text, and the like.

II. Exemplary Operating Environment

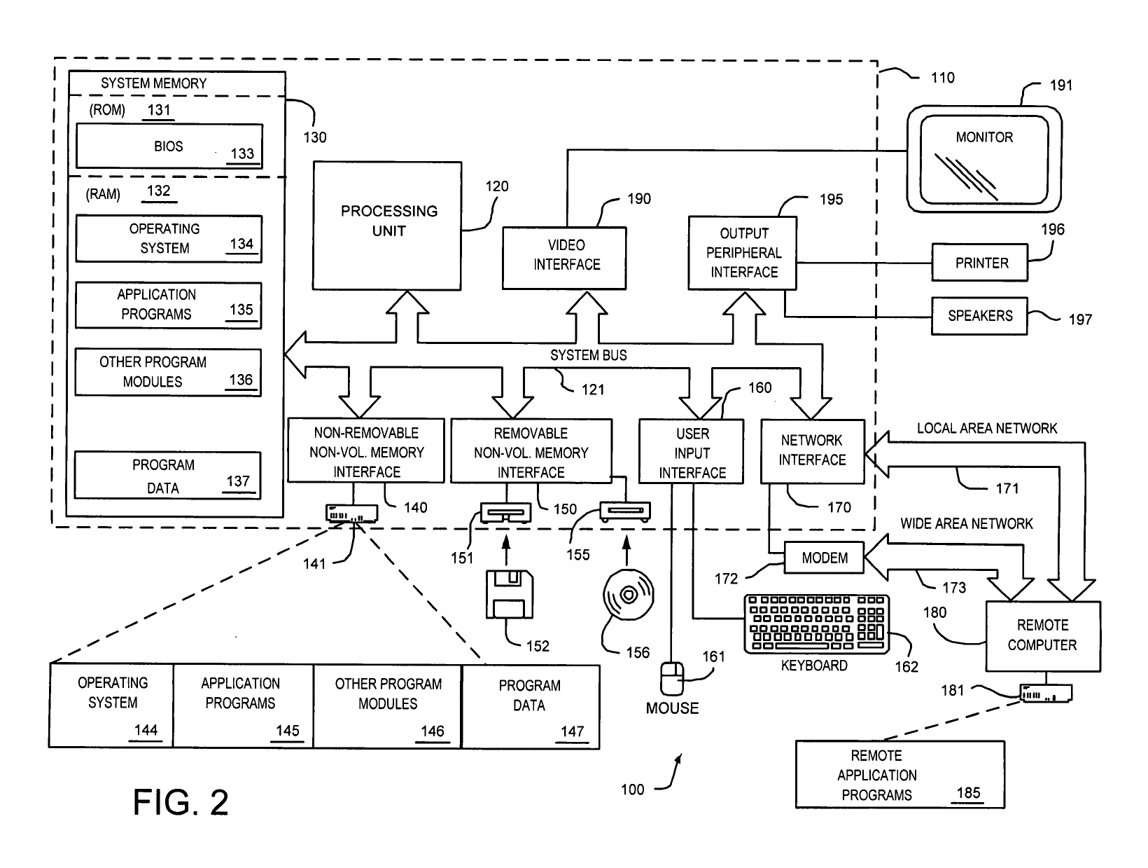

FIG. 2 illustrates an example of a suitable computing system environment 100 on which the system for viewing protected content may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 2, the exemplary system 100 for implementing the invention includes a general purpose-computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/nonremovable, volatile/nonvolatile computer storage media. By way of example only, FIG. 2 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

III. Systems and Methods of the Invention

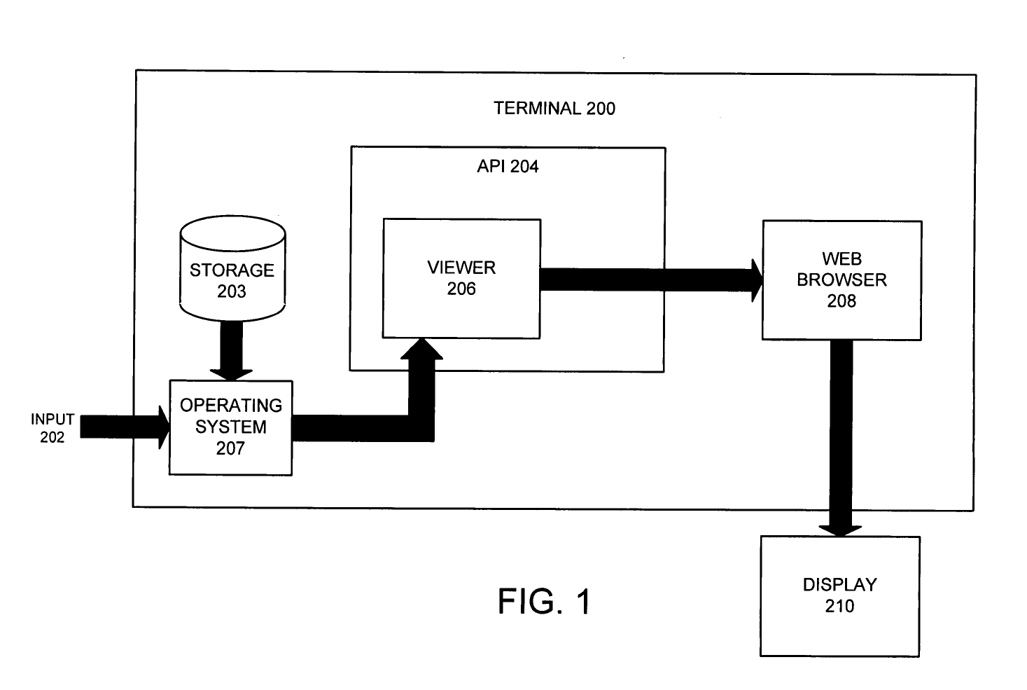

As set forth above, FIG. 1 illustrates a system for implementing a fixed-format viewer, in accordance with an embodiment of the invention. As described above with respect to FIG. 2, the system may include one or more user computers.

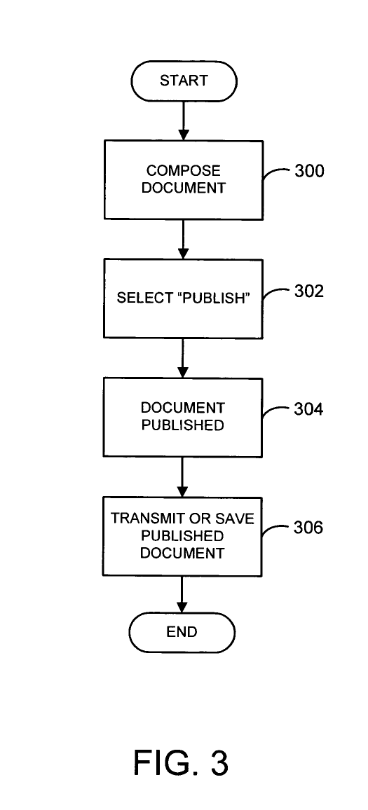

FIG. 3 is a flow chart illustrating a method for publishing a fixed-format document in accordance with an embodiment of the invention. As shown in FIG. 3, a user may begin by composing a document 300. The document is composed, for example, using a document application such as Word, Excel, PowerPoint, or the like. The document application used to compose the document is known as the “native application” of the document. The native application of the document may use routines, protocols, and tools provided by the API 204.

The method continues in step 302, wherein the user selects to publish the document. The user may elect to publish the document, for example, using a user-selectable option provided by the native application. For example, if the document has been composed in Word, the user may select “File” from the toolbar, select “Print” from the drop-down box, and then select “Print to Fixed Format.” Other selectable options provided by Word and other native applications are possible. The native application implements the selectable options using the API 204.

In step 304, the document is published by the native application and/or the viewer. Publishing the document includes, for example, creating a new “published document” by adding a layer of formatting to the original document, as specified by the API 204. The published document is a fixed file, which may not be edited or altered. Furthermore, the published document has a particular fixed-file content type, and the published document can be recognized as having the particular fixed-file content type. In addition, all software code present in the original document has been removed or disabled such that the published document does not contain any executable code.

Because the published document cannot include code, viruses, or other potential hazards, there is no threat to the user's computer system when a published document is opened. Thus, there is no need to present the user with dialog boxes warning about potential hazards. This increases user comfort with the viewer and renders the viewer easier to use.

In step 306, the user may elect to transmit the published document via a network or some other means, or to save the published document to external storage or local storage. The option to transmit or save the published document may be presented to the user, for example, via a dialog box.

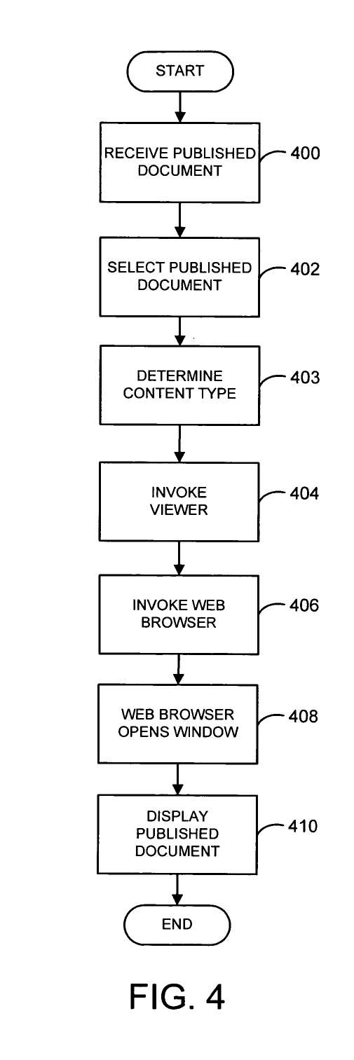

FIG. 4 is a flow chart illustrating a method for viewing a published document in accordance with an embodiment of the invention. As shown in FIG. 4, the method may begin in step 400, wherein a user may receive a published document, for example, via a network. Alternately, the published document may be retrieved from local or external storage. The method continues in step 402, wherein the user selects to open the published document. The user may select to open the published document, for example, by double-clicking on an icon representing the file or by some other method.

In step 403, it is determined that the published document is of a particular format or content type. In one implementation, the API determines that the published document is of a particular format or content type based on a file extension or other relevant information.

In step 404, the viewer is invoked, for example, by the API. In step 406, the web browser may be invoked, for example, either by the API or by the viewer. In step 408, the web browser opens a window or otherwise provides a host environment for the published document. In step 410, the viewer displays the published document to the user in the host environment provided by the web browser. Because the document cannot contain executable code, there is no need to present the user with dialog boxes warning about viruses or other potential hazards.

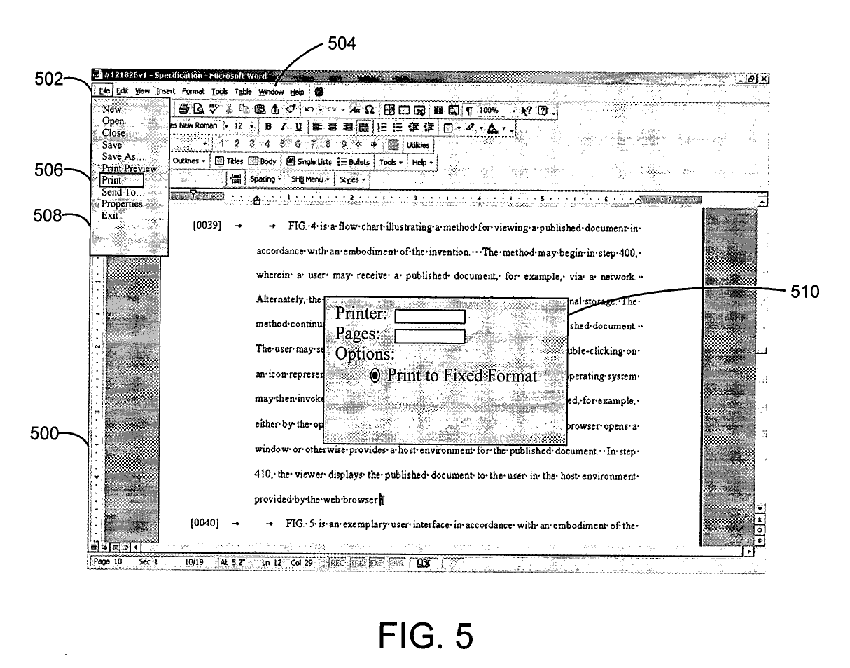

FIG. 5 is an exemplary user interface in accordance with an embodiment of the invention. As shown in FIG. 5, a user may elect to compose a document in a user interface window 500, using a native application such as Word, Excel, PowerPoint, or the like. The user may elect to publish the document, for example, using a user-selectable option provided by the native application in the user interface window 500, and implemented using the API 204. For example, the user may select a “File” option 502 from a toolbar 504, select a “Print” option 506 from a drop-down box 508, and then select a “Print to Fixed Format” option in a dialog box 510. Other selectable options in various native applications are possible.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

What is claimed is:

1. A method for providing viewing of a fixed-format document, the method comprising:
receiving a document into a viewer integrated with an application program interface;
determining whether the document is of a predetermined fixed-format content type; and
if the document is of the predetermined fixed-format content type, presenting the document to a user via a web browser.

2. The method of claim 1, wherein the viewer is implemented as a sealed application class within the application program interface.

3. The method of claim 1, wherein determining whether the document is of a predetermined fixed-format content type comprises:
identifying a file extension of the document.

4. The method of claim 1, wherein presenting the document to a user via the web browser comprises hosting the presentation of the document according to methods provided in the application program interface.

5. The method of claim 1, wherein the application program interface and the viewer are installed in a single installation.

6. A system for viewing a fixed-format document, comprising:
an application program interface; and
a viewer integrated with the application program interface,
wherein the application program interface and the viewer are installed in a single installation.

7. The system of claim 6, further comprising a sealed application class within the application program interface for implementing the viewer.

8. The system of claim 6, wherein the viewer includes first computer-executable instructions, the first instructions being executable to determine whether a document is of a predetermined fixed-format content type.

9. The system of claim 8, wherein the first instructions are executable to determine whether a document is of a predetermined fixed-format content type by identifying a file extension of the document.

10. The system of claim 6, wherein the viewer includes second computer-executable instructions, the second instructions being executable to present a document to a user.

11. The system of claim 10, wherein the second instructions are executable to present a document to a user via a web browser.

12. The system of claim 11, further comprising methods provided in the application program interface for hosting the presentation of the document by the web browser.

13. A user interface system for generating a fixed-format document, comprising:
a user-selectable print-to-fixed-format option, presented to a user in a document's native environment, that generates a fixed-format document in accordance with an application program interface,
wherein the fixed-format document is viewable via a viewer, the viewer being integrated with the application program interface.

14. The system of claim 13, wherein the viewer is implemented as a sealed application class within the application program interface.

15. The system of claim 13, wherein the fixed-format document is of a predetermined fixed-format content type.

16. The system of claim 15, wherein the fixed-format document has a file extension indicating the fixed-format content type.

17. The system of claim 13, wherein the fixed-format document is generated by adding formatting to an existing document.

18. The system of claim 13, wherein the fixed-format document is generated by removing and/or disabling computer-executable instructions in an existing document.
